(19) United States
(12) Patent Application Publication
(10) Pub. No.: US 2011/0276465 A1
(43) Pub. Date: Nov. 10, 2011

(54) MID TRANSACTION SUSPENSE AND MICRO LOAN METHOD AND MODULE

(76) Inventors: Stuart MACKINNON, Dallas, TX (US); Toby SALSMAN, Harvey, LA (US)

(21) Appl. No.: 13/100,960

(22) Filed: May 4, 2011

Related U.S. Application Data
(60) Provisional application No. 61/343,858, filed on May 5, 2010.

(51) Int. Cl. G06Q 40/00

(52) U.S. Cl. 705/38

(57) ABSTRACT

A real-time transaction interrogation and determination module that can identify if a cardholder transaction has been declined for insufficient funds. This module, 2^{nd} Chance, identifies if a transaction will be declined as NSF then routes the transaction request to the loan company, lender, and/or card issuer via the a Web Service to request a micro loan. Should the loan request be approved, the cardholders available funds are increased by the approved loan amount via online card load and the transaction is approved and returned to the merchant/ATM. If the request is denied, the declined transaction response is returned to the merchant/ATM as NSF.

This application claims priority from U. S. Provisional application Ser. No. 61/343,858 (“the '858 application”) filed May 5, 2011. The '858 application is incorporated herein by reference.

### BACKGROUND OF THE INVENTION

This invention relates to electronic processing of financial transactions, often referred to as EFT. Specifically this invention relates to the receipt, processing and authorization of card based transactions, originated by a card holder.

### SUMMARY OF THE INVENTION

The inventive mid transaction suspense and micro loan method and module (known herein as the “2^{nd} Chance Transaction Service” or “2^{nd} Chance”) offers an enhanced extension to payroll loan programs, popular with many cardholders that provide additional functionality to the unbanked population. Traditionally cardholders seeking to take advantage of a payroll loan would need to visit or contact a loan office (store front) or use an on-line application to request a loan or additional funding if their available balance on their card was insufficient. The 2^{nd} Chance Transaction Service provides this functionality instantly within a payment transaction by actively monitoring enrolled cardholders for any transactions they attempt that are declined due to insufficient funds. Upon identification of an insufficient funds decline response, the service suspends the transaction and delivers a micro loan request to the company with whom the cardholder is registered for loan advances and/or overdraft protection. The loan company has the ability to respond with a micro-loan amount, the value of which is immediately loaded onto the card. The transaction is subsequently released from suspense and resubmitted for approval, which is then passed back to the originating merchant. The entire process takes place within the timeframe allowed for transaction processing and response and neither the cardholder nor the merchant is aware of the back end processes as they occur. This ensures the consumer interaction at the merchant is not changed.

The present invention comprises a real-time transaction interrogation and determination module that can identify if a cardholder transaction has been declined for insufficient funds (known generally as “NSF”). This module, known herein as the “2^{nd} Chance”, identifies if a transaction will be declined as NSF then routes the transaction request to the payroll loan company via a Web Service to request a payroll loan (Micro Loan). Should the loan request be approved, the cardholder's available funds are increased by the approved loan amount via an online card load and the transaction is approved and returned to the merchant/ATM. If the request is denied, the declined transaction response is returned to the merchant/ATM as NSF.

The 2^{nd} Chance module receives the authorization response from the Card Authorization Database and examines the response code in ISO8593 Field 39. If the response code is ISO8583 Response Code 51 (Not Sufficient Funds, “NSF”), the module will suspend that transaction, preventing the declined transaction from returning to the merchant. ISO8583 is the International Organization for Standardization standard for systems that exchange electronic transactions made by cardholders using payment cards.

The 2^{nd} Chance module will then initiate a request for a micro loan (“Top-Up”) to the loan company that the cardholder has registered with for the service. The response from the loan company defines the next step for the 2^{nd} Chance module.

If the loan company declines to provide a loan, the transaction is released and subsequently delivered to the originating merchant terminal as declined.

If the loan company provides a loan, the 2^{nd} Chance module will perform a load funds transaction against the card account, such that the card balance is sufficient to allow the approval of the currently suspended transaction. The 2^{nd} Chance module then re-submits the suspended transaction to the Card Authorization Database where it will be approved, and sent back to the originating merchant terminal as approved.

The design method of this module provides in-flight micro loan advances to registered, eligible cardholders without any requirement for changes by the merchant or within the payment card networks. The normal payment interaction flow between the cardholder and the merchant or terminal is not altered in any way.

### BRIEF DESCRIPTION OF THE DRAWINGS

FIG. 1 is a simple flow chart.

FIG. 2 is a detailed flow chart.

FIG. 3 is a more detailed view of the interaction depicted in the detailed flow chart of FIG. 2.

### DETAILED DESCRIPTION OF THE INVENTION

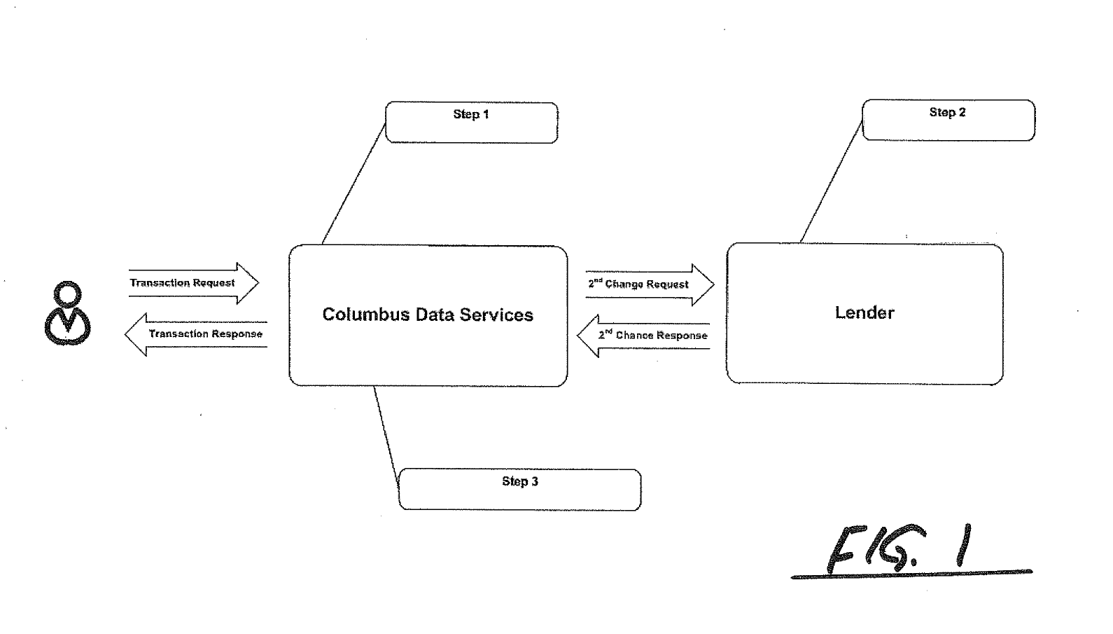

The steps as depicted in FIG. 1 are as follows:

1. The service provider, herein depicted as Columbia Data Services (“CDS”) determines that cardholder available funds are less than available balance and that cardholder participates in 2^{nd} Chance Service. Transaction is suspended and a request is sent to the loan company, lender, and/or card issuer for Approval.

2. The loan company, lender, and/or card issuer receives request and determines cardholder eligibility for TopUp or Overdraft. Returns response code to CDS with either a decline, a TopUp amount or an Overdraft amount.

3. Upon receipt of a TopUp approval, CDS will perform a funds load to the card for the amount specified in the response. The suspended transaction will then be approved based on the new available balance. Han overdraft approval is returned, the cardholder account will be configured to allow overdraft to the amount specified. If the request was declined, the decline response will be returned to the merchant/ATM.

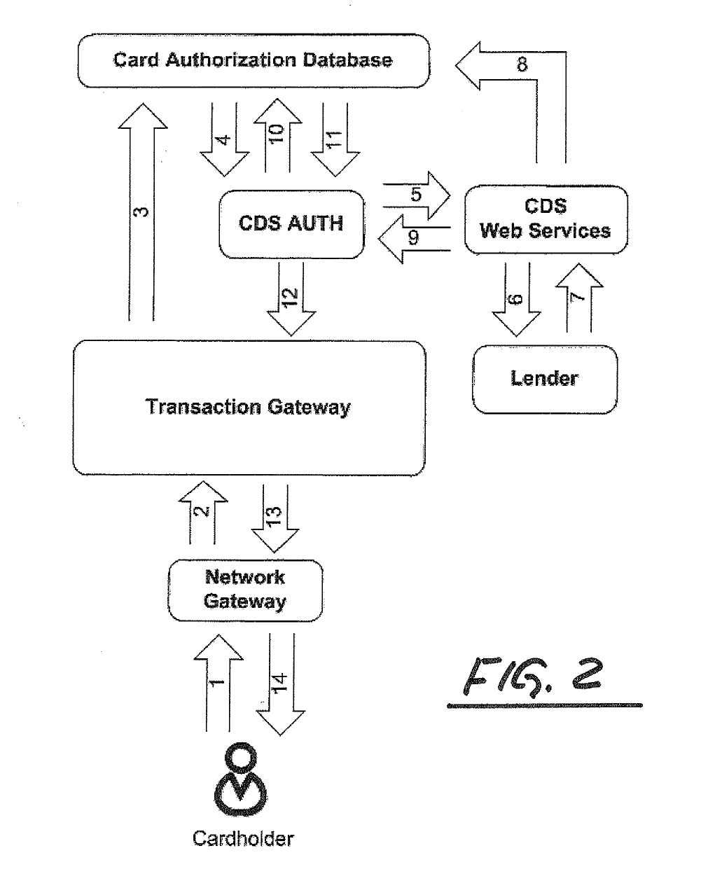

The more detailed steps as depicted in FIG. 2 are as follows:

1. Transaction request received from network

2. Transaction is routed into the Transaction Gateway and identified as an SVC card by BIN (“Bank Identification Number”)

3. Transaction is routed to Card Authorization Database (CAD) for authorization

4. CAD returns transaction response code 51 (Not Sufficient Funds)

5. CDS Auth node interrogates the response code, identifies response code 51 and the card program is participating in the credit offer and routes the transaction to the CDS Web Service

6. The Web Service places an API (“Application Programming Interface”) call to the loan company, lender, and/or card issuer with the following information;
a. Card #
b. Available Balance
c. Amount of Transaction

7. The loan company, lender, and/or card issuer will respond with the following information;
a. Amount of Credit Advance or Overdraft
b. Approve (‘00’) or Decline (‘51’)
8. If credit advance is approved then customer is sent a load transaction in that amount to their card. If Overdraft is approved an administrative transaction sets the overdraft amount on the cardholder account.

9. The suspend release is sent to CDS Auth node where the transaction has been suspended

10. The suspended transaction is sent back to the Card Authorization Database for approval

11. The transaction is approved due to the successful action in Step 8 and responded to with a 00 (Approved) response code

12. CDS Auth node interrogates the response code, identifies response code 00 and sends the transaction to the Transaction Gateway.

13. The transaction is returned to the Network Gateway

14. The transaction is returned to the merchant Notes:
If this is declined at any point, transaction will be declined and the decline will be sent out to merchant.
Transaction must complete with in 5 seconds so company performing the cash advance overdraft needs to respond within 1 second

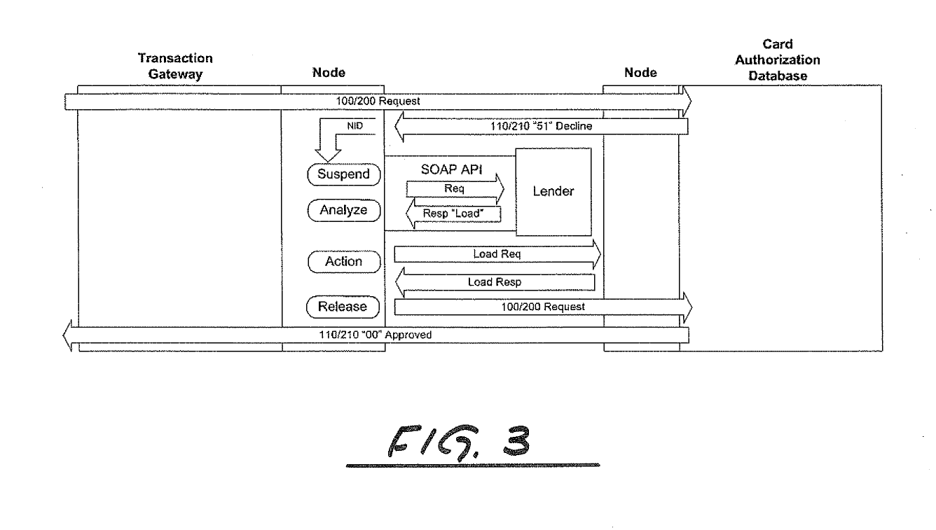

FIG. 3 provides a more detailed view of the interaction between the various modules as described above. In FIG. 3, API means Application Programming Interface and SOAP means Simple Object Access Protocol.

We claim:

1. A module for real time electronic processing of a financial transaction request with a merchant by a cardholder participating in a loan program with a card account through a service provider to suspend the transaction and make a micro-loan request to a lender comprising the steps of:
identification of an insufficient funds decline response;
suspension of the transaction;
routing the transaction to the lender to request a micro loan;
crediting the cardholder's card account with a micro-loan if approved;
release the suspension of the transaction and complete the transaction.

2. The module of claim 1, wherein the steps further comprise:
identification of an insufficient funds decline response and suspension of the transaction further comprises the steps of;
receiving a transaction request from a network gateway,
routing the transaction into a transaction gateway and identifying the stored value card by bank identification number,
routing the transaction to a card authorization database for authorization,
returning a not sufficient funds response code from the card authorization database,
interrogation of the response code by a service provider authorization node, to identify the not sufficient funds response code and that the card holder is a participant in the loan program and then routing the transaction to the service provider web service, wherein the web service will then place an application programming interface call to the lender with information comprising the cardholder's card number, available balance and amount of transaction;
response by the lender with information comprising amount of credit advance or overdraft and approval code or decline code,
upon an approval code response for a credit advance then that amount is loaded to the cardholder's card,
upon an approval code response for an overdraft then that overdraft amount is set on the cardholder's account
sending a suspension release to the service provider authorization node to release the transaction and sending the transaction back to the card authorization database for approval
approval of the transaction is approved and responded to with an approved response code
interrogation of the response code by the service provider authorization node, to identify the approved response code and sending the transaction to the transaction gateway.
returning the transaction to the network gateway for return to the merchant

3. A method for real time electronic processing of a financial transaction request by a cardholder with a card account through a service provider to suspend the transaction and make a micro-loan request to a loan company comprising the steps of:
identification of an insufficient funds decline response;
suspension of the transaction;
routing the transaction to the loan company to request a micro loan;
crediting the cardholder's card account with a micro-loan if approved;
release the suspension of the transaction and complete the transaction.

4. The method of claim 3, further comprising the steps of:
identification of an insufficient funds decline response and suspension of the transaction further comprises the steps of;
receiving a transaction request from a network gateway,
routing the transaction into a transaction gateway and identifying the stored value card by bank identification number,
routing the transaction to a card authorization database for authorization,
returning a not sufficient funds response code from the card authorization database,
interrogation of the response code by a service provider authorization node, to identify the not sufficient funds response code and that the card holder is a participant in the loan program and then routing the transaction to the service provider web service, wherein the web service will then place an application programming interface call to the lender with information comprising the cardholder's card number, available balance and amount of transaction;
response by the lender with information comprising amount of credit advance or overdraft and approval code or decline code,
upon an approval code response for a credit advance then that amount is loaded to the cardholder's card,
upon an approval code response for an overdraft then that overdraft amount is set on the cardholder's account
sending a suspension release to the service provider authorization node to release the transaction and sending the transaction back to the card authorization database for approval
approval of the transaction is approved and responded to with an approved response code
interrogation of the response code by the service provider authorization node, to identify the approved response code and sending the transaction to the transaction gateway.
returning the transaction to the network gateway for return to the merchant.
